(19) United States
(12) Patent Application Publication
(10) Pub. No.: US 2017/0331705 A1
(43) Pub. Date: Nov. 16, 2017

(54) Resource Scaling Method on Cloud Platform and Cloud Platform

(71) Applicant: Huawei Technologies Co., Ltd., Shenzhen (CN)

(72) Inventors: Enlong Jiang, Shenzhen (CN); Hewei Liu, Hangzhou (CN)

(21) Appl. No.: 15/663,140

(22) Filed: Jul. 28, 2017

Related U.S. Application Data
(63) Continuation of application No. PCT/CN2015/084178, filed on Jul. 16, 2015.

(30) Foreign Application Priority Data
Jan. 30, 2015 (CN) 201510054470.0

(51) Int. Cl. H04L 12/24; H04L 12/26

(52) U.S. Cl. CPC H04L 41/5025; H04L 43/0817; H04L 41/147; H04L 41/5096

(57) ABSTRACT

A resource scaling method for dynamically allocating resources to an application deployed on a cloud platform. The method includes predicting, at a first moment according to a prediction policy, a service indicator of a service that is at a second moment later than the first moment, to obtain a predicted service indicator, determining, according to the predicted service indicator and a mapping relationship between a service indicator and a resource amount required by the application, a resource amount required by the application at the second moment, and adjusting, before the second moment arrives, a resource amount of the application to the determined resource amount.

### CROSS-REFERENCE TO RELATED APPLICATIONS

This application is a continuation of International Application No. PCT/CN2015/084178, filed on Jul. 16, 2015, which claims priority to Chinese Patent Application No. 201510054470.0, filed on Jan. 30, 2015, The disclosures of the aforementioned applications are hereby incorporated by reference in their entireties.

### TECHNICAL FIELD

The present disclosure relates to the field of information technologies, and in particular, to a resource scaling method on a cloud platform and a cloud platform.

### BACKGROUND

Platform as a service (PaaS) is one of three major service models in a cloud computing field, and is a business model for providing a cloud platform as a service. A developer develops various applications to bear different services. For example, a Web application may be developed to implement an instant messaging service. In addition, the developer may deploy the developed application to a cloud platform. The cloud platform provides a running environment and resources, such as an instance and memory, for the application, and supports a multi-instance deployment of the application, to support a high concurrency external user access.

To ensure good user experience when a service is provided for a user by using the application deployed on the cloud platform, more system resources need to be allocated to the application. More system resources occupied by an application indicate higher operating costs of the application. At present, an automatic capacity expansion technology is usually used to dynamically allocate a system resource to an application, so that system resource usage of the cloud platform is improved while a service indicator is ensured, and operating costs of the application are reduced. Using the automatic capacity expansion technology to dynamically allocate a system resource to an application is as follows: The cloud platform collects a resource usage status of the application in real time, such as information about central processing unit (CPU) usage of the application, memory usage of the application, and a concurrent request quantity of the application, and adjusts, in real time according to the collected information, a system resource allocated to the application. For example, if the CPU usage exceeds 80% and this case lasts for one minute, one application instance is added. If the CPU usage is lower than 20% and this case lasts for one minute, one application instance is deducted, to reduce the operating costs of the application.

However, in a service traffic burst scenario on the cloud platform, when the existing automatic capacity expansion technology is used to dynamically adjust a resource of an application, because a specific time is required for a process of adjusting a system resource amount occupied by the application, the system resource amount occupied by the application cannot be quickly increased or decreased. Therefore, some services cannot be processed in the service traffic burst scenario, and normal running of the application is affected.

### SUMMARY

Embodiments of the present disclosure provide a resource scaling method on a cloud platform and a cloud platform, so as to dynamically allocate resources to an application deployed on the cloud platform, and ensure that the application can run normally in a service traffic burst scenario.

According to a first aspect, an embodiment of the present disclosure provides a resource scaling method on for dynamically allocating resources to an application deployed on a cloud platform, where the application is used to bear a corresponding service, to implement a particular service function, and the method includes predicting, at a first moment according to a prediction policy, a service indicator of the service that is at a second moment, to obtain a predicted service indicator, where the prediction policy is used to indicate a prediction manner for a service indicator, and the second moment is later than the first moment, determining, according to the predicted service indicator and a mapping relationship between a service indicator and a resource amount required by the application, a resource amount required by the application at the second moment, and adjusting, before the second moment arrives, a resource amount of the application to the resource amount required by the application at the second moment.

With reference to the first aspect, in a first implementation manner, the prediction policy includes a service indicator prediction manner based on historical data. The predicting, according to a prediction policy, a service indicator of the service that is at a second moment includes obtaining a service indicator of the service that is within a preset time interval before the first moment, and predicting the service indicator of the service that is at the second moment according to the obtained value.

With reference to the first implementation manner of the first aspect, in a second implementation manner of the first aspect, the predicting the service indicator of the service that is at the second moment according to the obtained value includes determining a change track of the service indicator of the service that is within the preset time interval before the first moment according to the obtained value, and predicting the service indicator of the service that is at the second moment according to the change track, where the preset time interval includes a third moment and a fourth moment that are adjacent to each other, and the change track indicates a value relationship between a service indicator of the service at the third moment and a service indicator of the service at the fourth moment and an increased or decreased value of the service indicator of the service at the fourth moment compared with the service indicator of the service at the third moment.

With reference to the first aspect, in a third implementation manner, the prediction policy includes a service indicator prediction manner based on a specified time. The predicting, according to a prediction policy, a service indicator of the service that is at a second moment includes obtaining a service indicator of the service that is at a historical moment before the first moment, and predicting the service indicator of the service that is at the second moment according to the obtained value, where the historical moment includes at least one moment, a time interval between any moment in the historical moment and the second moment is N preset periods, and N is a positive integer.

With reference to any one of the first aspect, or the first to the third implementation manners of the first aspect, in a fourth implementation manner of the first aspect, the service indicator of the service includes one or a combination of the following information: a concurrent request quantity of the service, access traffic of the service, a Hypertext Transfer Protocol (HTTP) request quantity of the service, or a user quantity of the service.

With reference to the first aspect, in a fifth implementation manner, the adjusting a resource amount of the application to the resource amount required by the application at the second moment includes sending an instruction to a cloud platform controller, where the instruction is used to instruct the cloud platform controller to adjust the resource amount of the application to the resource amount required by the application at the second moment.

With reference to the first aspect or the fifth implementation manner of the first aspect, in a sixth implementation manner of the first aspect, the resource amount of the application includes any one or a combination of the following information: a quantity of instances deployed by the application, central processing unit CPU usage of the application, memory usage of the application, disk usage of the application, or a network input/output I/O device throughput occupied by the application.

In the first aspect, a service indicator of a service at a second moment is predicted at a first moment according to a prediction policy, to obtain a predicted service indicator, and then a resource amount required by an application at the second moment is determined according to the predicted service indicator and a mapping relationship between a service indicator and a resource amount required by the application. Before the second moment arrives, a resource amount of the application is adjusted to the resource amount required by the application at the second moment, so as to dynamically allocate resources to an application deployed on a cloud platform. In the first aspect, a service traffic burst moment may be set as the second moment. Therefore, a resource amount required by the application deployed on the cloud platform is dynamically adjusted by using the first aspect before the second moment arrives, so that in a service traffic burst scenario, the resource amount allocated to the application deployed on the cloud platform can maintain normal service running of the application, while high resource usage is ensured.

According to a second aspect, an embodiment of the present disclosure provides a resource scaling method for dynamically allocating resources to an application deployed on a cloud platform, where the application is used to bear a corresponding service, to implement a particular service function, and the method includes predicting, at a first moment according to a mapping relationship between a moment and a resource amount required by the application, a resource amount required by the application at a second moment, where the second moment is later than the first moment, and adjusting, before the second moment arrives, a resource amount of the application to the resource amount required by the application at the second moment.

With reference to the second aspect, in a first implementation manner, the mapping relationship between a moment and a resource amount required by the application is set based on a historical moment and a resource amount required by the application at the historical moment.

With reference to the second aspect, in a second implementation manner, the adjusting a resource amount of the application to the resource amount required by the application at the second moment includes sending an instruction to a cloud platform controller, where the instruction is used to instruct the cloud platform controller to adjust the resource amount of the application to the resource amount required by the application at the second moment.

With reference to the second aspect or the second implementation manner of the second aspect, in a third implementation manner of the second aspect, the resource amount of the application includes any one or a combination of the following information: a quantity of instances deployed by the application, central processing unit (CPU) usage of the application, memory usage of the application, disk usage of the application, or a network input/output (I/O) device throughput occupied by the application.

In the second aspect, a resource amount required by an application at a second moment is predicted at a first moment according to a mapping relationship between a moment and a resource amount required by the application, and then before the second moment arrives, a resource amount of the application is adjusted to the resource amount required by the application at the second moment, so as to dynamically allocate resources to an application deployed on a cloud platform. In the second aspect, a service traffic burst moment may be set as the second moment. Therefore, a resource amount required by the application deployed on the cloud platform is dynamically adjusted by using the second aspect before the second moment arrives, so that in a service traffic burst scenario, the resource amount allocated to the application deployed on the cloud platform can maintain normal service running of the application, while high resource usage is ensured.

According to a third aspect, an embodiment of the present disclosure provides a cloud platform for dynamically allocating resources to an application deployed on the cloud platform, where the application is used to bear a corresponding service, to implement a particular service function. The cloud platform includes a collection module, configured to collect a service indicator of the service that is before a first moment, a policy module, configured to configure a mapping relationship between a service indicator and a resource amount required by the application, a prediction module, configured to predict, at the first moment according to the service indicator of the service that is before the first moment and collected by the collection module, a service indicator of the service that is at a second moment, to obtain a predicted service indicator, where the second moment is later than the first moment; and determine, according to the predicted service indicator and the mapping relationship that is between a service indicator and a resource amount required by the application and that is configured by the policy module, a resource amount required by the application at the second moment, and an execution module, configured to adjust, before the second moment arrives, a resource amount of the application to the resource amount that is required by the application at the second moment and determined by the prediction module.

With reference to the third aspect, in a first implementation manner, the collection module is specifically configured to collect a service indicator of the service that is within a preset time interval before the first moment.

With reference to the first implementation manner of the third aspect, in a second implementation manner of the third aspect, when predicting, according to the service indicator of the service that is before the first moment and collected by the collection module, the service indicator of the service that is at the second moment, the prediction module is specifically configured to determine a change track of the service indicator of the service that is within the preset time interval before the first moment according to the service indicator of the service that is within the preset time interval before the first moment and collected by the collection module, and predict the service indicator of the service that is at the second moment according to the change track, where the preset time interval includes a third moment and a fourth moment that are adjacent to each other, and the change track indicates a value relationship between a service indicator of the service at the third moment and a service indicator of the service at the fourth moment and an increased or decreased value of the service indicator of the service at the fourth moment compared with the service indicator of the service at the third moment.

With reference to the third aspect, in a third implementation manner, the collection module is specifically configured to collect a service indicator of the service that is at a historical moment before the first moment, where the historical moment includes at least one moment, a time interval between any moment in the historical moment and the second moment is N preset periods, and N is a positive integer.

With reference to the third implementation manner of the third aspect, in a fourth implementation manner of the third aspect, when predicting, according to the service indicator of the service that is before the first moment and collected by the collection module, the service indicator of the service that is at the second moment, the prediction module is specifically configured to predict a service indicator of the service that is at the second moment according to the service indicator of the service that is at the historical moment before the first moment and collected by the collection module.

With reference to any one of the third aspect, or the first to the fourth implementation manners of the third aspect, in a fifth implementation manner of the third aspect, the service indicator of the service includes one or a combination of the following information: a concurrent request quantity of the service, access traffic of the service, a Hypertext Transfer Protocol HTTP request quantity of the service, or a user quantity of the service.

With reference to the third aspect, in a sixth implementation manner, the execution module is specifically configured to send an instruction to a cloud platform controller, where the instruction is used to instruct the cloud platform controller to adjust the resource amount of the application to the resource amount required by the application at the second moment.

With reference to the third aspect or the sixth implementation manner of the third aspect, in a seventh implementation manner of the third aspect, the resource amount of the application includes any one or a combination of the following information: a quantity of instances deployed by the application, central processing unit CPU usage of the application, memory usage of the application, disk usage of the application, or a network input/output I/O device throughput occupied by the application.

In the third aspect, by using a collection module, a policy module, a prediction module, and an execution module, a resource is dynamically allocated to an application deployed on a cloud platform. In the third aspect, a service traffic burst moment may be set as a second moment. Therefore, a resource amount required by the application deployed on the cloud platform is dynamically adjusted by using the third aspect before the second moment arrives, so that in a service traffic burst scenario, the resource amount allocated to the application deployed on the cloud platform can maintain normal service running of the application, while high resource usage is ensured.

According to a fourth aspect, an embodiment of the present disclosure provides a cloud platform for dynamically allocating resources to an application deployed on the cloud platform, where the application is used to bear a corresponding service, to implement a particular service function, and the cloud platform includes a policy module, configured to configure a mapping relationship between a moment and a resource amount required by the application, a prediction module, configured to predict, at a first moment according to a second moment and the mapping relationship that is between a moment and a resource amount required by the application and that is configured by the policy module, a resource amount required by the application at the second moment, where the second moment is later than the first moment, and an execution module, configured to adjust, before the second moment arrives, a resource amount of the application to the resource amount that is required by the application at the second moment and determined by the prediction module.

With reference to the fourth aspect, in a first implementation manner, the cloud platform further includes a collection module, configured to collect a resource amount required by the application at a historical moment, where the policy module is specifically configured to configure, according to the resource amount that is required by the application at the historical moment and collected by the collection module, the mapping relationship between a moment and a resource amount required by the application.

With reference to the fourth aspect, in a second implementation manner, the execution module is specifically configured to send an instruction to a cloud platform controller, where the instruction is used to instruct the cloud platform controller to adjust the resource amount of the application to the resource amount required by the application at the second moment.

With reference to the fourth aspect or the second implementation manner of the fourth aspect, in a third implementation manner of the fourth aspect, the resource amount of the application includes any one or a combination of the following information: a quantity of instances deployed by the application, central processing unit CPU usage of the application, memory usage of the application, disk usage of the application, or a network input/output I/O device throughput occupied by the application.

In the fourth aspect, by using a collection module, a policy module, a prediction module, and an execution module, a resource is dynamically allocated to an application deployed on a cloud platform. In the fourth aspect, a service traffic burst moment may be set as a second moment. Therefore, a resource amount required by the application deployed on the cloud platform is dynamically adjusted by using the fourth aspect before the second moment arrives, so that in a service traffic burst scenario, the resource amount allocated to the application deployed on the cloud platform can maintain normal service running of the application, while high resource usage is ensured.

### BRIEF DESCRIPTION OF THE DRAWINGS

FIG. 1 is a schematic flowchart of a resource scaling method on a cloud platform according to an embodiment of the present disclosure;

FIG. 2 is a schematic flowchart of a resource scaling method on a cloud platform according to an embodiment of the present disclosure;

FIG. 3 is a schematic diagram of a storage form of a mapping relationship between a moment and a resource amount of an application according to an embodiment of the present disclosure;

FIG. 4 is a schematic diagram of a before-after scaling effect of a resource amount of an application according to an embodiment of the present disclosure;

FIG. 5 is a schematic structural diagram of a cloud platform according to an embodiment of the present disclosure; and

FIG. 6 is a schematic structural diagram of a cloud platform according to an embodiment of the present disclosure.

### DETAILED DESCRIPTION OF ILLUSTRATIVE EMBODIMENTS

The following describes the technical solutions in the embodiments of the present disclosure with reference to the accompanying drawings in the embodiments of the present disclosure. Apparently, the described embodiments are merely some but not all of the embodiments of the present disclosure.

The technical solutions in the present disclosure are applicable to a cloud platform system, which is referred to as a cloud platform in the following. The cloud platform is a server platform, a business model in which the cloud platform provides a service is platform as a service (PaaS). PaaS is one of three major service models in a cloud computing field. A user served by the cloud platform is an application developer. The developer deploys a developed application to the cloud platform, and the cloud platform provides a running environment and a resource, such as an instance and memory, for the application, and supports a multi-instance deployment of the application, to support a high concurrency external user access.

A scenario in the embodiments of the present disclosure is a service traffic burst scenario of an application on the cloud platform. One or more applications are deployed on the cloud platform. Each application is used to bear one type of service, to implement a corresponding service function. The application may also be considered as a running mode of the service. For example, a Web service type application hosted on the cloud platform may be used to implement an instant messaging service. Usually, one application corresponds to one service. In some cases, multiple applications may cooperatively implement one service, and the embodiments of the present disclosure do not impose a specific limitation. In the embodiments of the present disclosure, a resource amount required by a service at a traffic burst moment is predicted before the service traffic burst moment, and a resource amount of an application is adjusted to the predicted resource amount before the service traffic burst moment arrives. When a resource is dynamically allocated to the application deployed on the cloud platform, it is ensured that in a service traffic burst scenario, sufficient resources can still be allocated to the application deployed on the cloud platform, to perform normal service running.

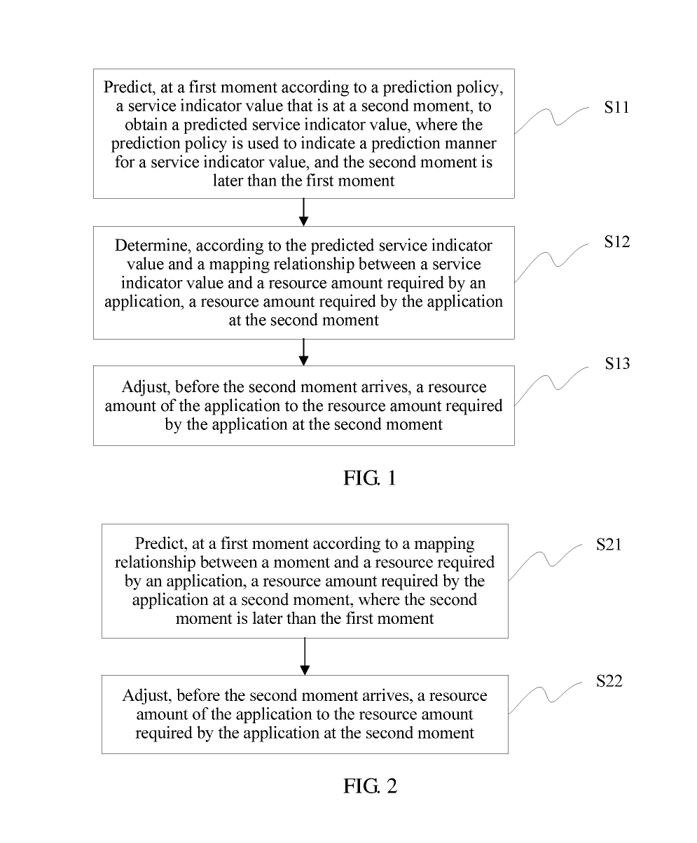

As shown in FIG. 1, an embodiment of the present disclosure provides a resource scaling method for dynamically allocating resources to an application deployed on a cloud platform, where the application is used to bear a corresponding service, to implement a particular service function, and the method includes:

S11. Predict, at a first moment according to a prediction policy, a service indicator of the service that is at a second moment, to obtain a predicted service indicator, where the prediction policy is used to indicate a prediction manner for a service indicator, and the second moment is later than the first moment.

S12. Determine, according to the predicted service indicator and a mapping relationship between a service indicator and a resource amount required by the application, a resource amount required by the application at the second moment.

S13. Adjust, before the second moment arrives, a resource amount of the application to the resource amount required by the application at the second moment.

In this embodiment, the service indicator of the service may be at least one of the following: a concurrent request quantity of the service, access traffic of the service, a Hypertext Transfer Protocol HTTP request quantity of the service, a user quantity of the service, or the like. The service indicator is a specific value corresponding to the service indicator. For example, if the service indicator is the concurrent request quantity of the service, the service indicator is a value of the concurrent request quantity.

In this embodiment, the resource amount of the application may be at least one of the following: a quantity of instances deployed by the application, central processing unit CPU usage of the application, memory usage of the application, disk usage of the application, or a network input/output I/O device throughput occupied by the application.

In this embodiment, the first moment is usually a current moment, the second moment is usually a service traffic burst moment, and the second moment is later than the first moment. For example, when it can be determined, according to past experience, that a service traffic burst case will occur on the cloud platform within a period of time, such as holidays or a buying spree time, a start moment of this period of time may be set as the second moment. Alternatively, the second moment may be set as another moment, and this is not specifically limited in this embodiment of the present disclosure. Optionally, a time interval between the first moment and the second moment is greater than or equal to a time required for adjusting the resource amount of the application.

In this embodiment, for predicting, according to the prediction policy, the service indicator of the service that is at the second moment in S11, the following provides two specific implementation manners.

In a first implementation manner, the prediction policy is a service indicator prediction manner based on historical data. Specifically, the predicting, according to a prediction policy, a service indicator of the service that is at a second moment includes obtaining a service indicator of the service that is within a preset time interval before the first moment; and predicting the service indicator of the service that is at the second moment according to the obtained value.

Optionally, historical data is pre-collected by using the cloud platform, wherein the historical data include service indicator data being collected at some historical moments, and noise reduction processing is performed on the historical data so as to remove sporadic jitter data from the historical data. Finally, the processed historical data is stored into a database of the cloud platform, so that a service indicator is subsequently predicted by using the historical data. For example, 30 pieces of historical data are obtained by means of sampling, and an average value of the 30 pieces of historical data is calculated. Differences between the 30 pieces of historical data and the average value are separately obtained, and the differences are ranked in order. Historical data corresponding to top 5% larger values in the difference ranking is deleted, and the deleted historical data is jitter data. Historical data that is not deleted is stored into the database of the cloud platform, so that a service indicator is subsequently predicted by using the historical data.

For the first implementation manner, the predicting the service indicator of the service that is at the second moment according to the obtained value includes determining a change track of the service indicator of the service that is within the preset time interval before the first moment according to the obtained value, and predicting the service indicator of the service that is at the second moment according to the change track, where the preset time interval includes a third moment and a fourth moment that are adjacent to each other, and the change track indicates a value relationship between a service indicator of the service at the third moment and a service indicator of the service at the fourth moment and an increased or decreased value of the service indicator of the service at the fourth moment compared with the service indicator of the service at the third moment.

For the first implementation manner, for example, the first moment (that is, the current moment) is 7:50 p.m., and the second moment is 8:00 p.m. Service indicators of the service at all exact hours within a time interval from 8:00 p.m. yesterday to 7:50 p.m. today are obtained, and a change track of the service indicators of the service at the exact hours is determined according to the obtained values corresponding to the exact hours. The change track may include a value relationship between values corresponding to adjacent exact hours and a relative increased or decreased value. Further, a service indicator of the service at the second moment (8:00 p.m.) may be predicted according to the change track.

In a second implementation manner, the prediction policy is a service indicator prediction manner based on a specified time. Specifically, the predicting, according to a prediction policy, a service indicator of the service that is at a second moment includes obtaining a service indicator of the service that is at a historical moment before the first moment, and predicting the service indicator of the service that is at the second moment according to the obtained value, where the historical moment includes at least one moment, a time interval between any moment in the historical moment and the second moment is N preset periods, and N is a positive integer.

For the second implementation manner, for example, the first moment (that is, a current moment) is 7:50 p.m., and the second moment is 8:00 p.m. A service indicator of the service at 8:00 p.m. each day before today is obtained, and then a service indicator of the service at 8:00 p.m. today is predicted according to the obtained value.

For the predicting, according to a prediction policy, a service indicator of the service that is at a second moment in S11, in addition to the foregoing two implementation manners, a service indicator may further be predicted based on a service growth rule. For example, according to assessment by authoritative institutions, the service grows at a rate of 8% each year. Alternatively, a service indicator is predicted based on operating costs of the service. The operating costs of the service are directly proportional to a resource amount of an application for bearing the service. For example, an electricity price during the day is high, and therefore, the operating costs of the service during the day are relatively high. Without affecting a service level agreement (Service-Level Agreement, SLA), the resource amount of the application may be decreased, to reduce the operating costs of the service.

In this embodiment of the present disclosure, an instruction may be sent to a cloud platform controller to adjust the resource amount of the application to the resource amount required by the application at the second moment. The instruction is used to instruct the cloud platform controller to adjust the resource amount of the application to the resource amount required by the application at the second moment.

In this embodiment of the present disclosure, the mapping relationship between a service indicator and a resource amount required by the application may be manually configured. For example, the mapping relationship between a service indicator and a resource amount required by the application is configured based on personal experience or authoritative data from a third-party company. Alternatively, the mapping relationship between a service indicator and a resource amount required by the application may be automatically calculated. That is, a resource amount that is required by an application and that corresponds to a service indicator is calculated according to historical running status information of the application, to complete configuration of the mapping relationship between a service indicator and a resource amount required by the application.

FIG. 4 is a schematic diagram of a before-after scaling effect of a resource amount of an application. Horizontal scaling refers to adjustment of an instance quantity of the application, and vertical scaling refers to adjustment of memory of the application. The instance quantity of the application is three before the horizontal scaling. By means of the technical solutions in the foregoing embodiment, the instance quantity of the application is horizontally scaled to five before the second moment arrives. The memory of the application is 64 M before the vertical scaling. By means of the technical solutions in the foregoing embodiment, the memory of the application is vertically scaled to 128 M before the second moment arrives. Therefore, before the second moment (usually the service traffic burst moment) arrives, normal running of the application can be ensured.

By means of the foregoing technical solutions, resources are dynamically allocated to an application deployed on a cloud platform. A service traffic burst moment may be set as a second moment, to dynamically adjust, before the service traffic burst moment arrives, a resource amount required by the application deployed on the cloud platform, so that in a service traffic burst scenario, the resource amount allocated to the application deployed on the cloud platform can maintain normal service running of the application, while high resource usage is ensured. Because operating costs of the application are directly proportional to a resource amount occupied by the application, by means of the technical solutions, resource wastes and relatively high operating costs that are caused by allocating excessive cloud platform resources to the application are avoided in this embodiment of the present disclosure.

As shown in FIG. 2, an embodiment of the present disclosure provides a resource scaling method for dynamically allocating resources to an application deployed on a cloud platform, where the application is used to bear a corresponding service, to implement a particular service function, and the method includes the following.

S21. Predict, at a first moment according to a mapping relationship between a moment and a resource amount required by the application, a resource amount required by the application at a second moment, where the second moment is later than the first moment.

S22. Adjust, before the second moment arrives, a resource amount of the application to the resource amount required by the application at the second moment.

In this embodiment, the resource amount of the application may be at least one of the following: a quantity of instances deployed by the application, central processing unit CPU usage of the application, memory usage of the application, disk usage of the application, or a network input/output I/O device throughput occupied by the application.

In this embodiment of the present disclosure, an instruction may be sent to a cloud platform controller to adjust the resource amount of the application to the resource amount required by the application at the second moment. The instruction is used to instruct the cloud platform controller to adjust the resource amount of the application to the resource amount required by the application at the second moment.

In this embodiment of the present disclosure, the mapping relationship between a moment and a resource amount required by the application may be based on a historical moment and a resource amount required by the application at the historical moment. Specifically, the mapping relationship between a moment and a resource amount required by the application may be automatically calculated. That is, a resource amount that is required by an application and that corresponds to a moment is calculated according to historical running status information of the application, to complete configuration of the mapping relationship between a moment and a resource amount required by the application. Alternatively, the mapping relationship between a moment and a resource amount required by the application may be manually configured. For example, the mapping relationship between a moment and a resource amount required by the application is configured based on personal experience or authoritative data from a third-party company.

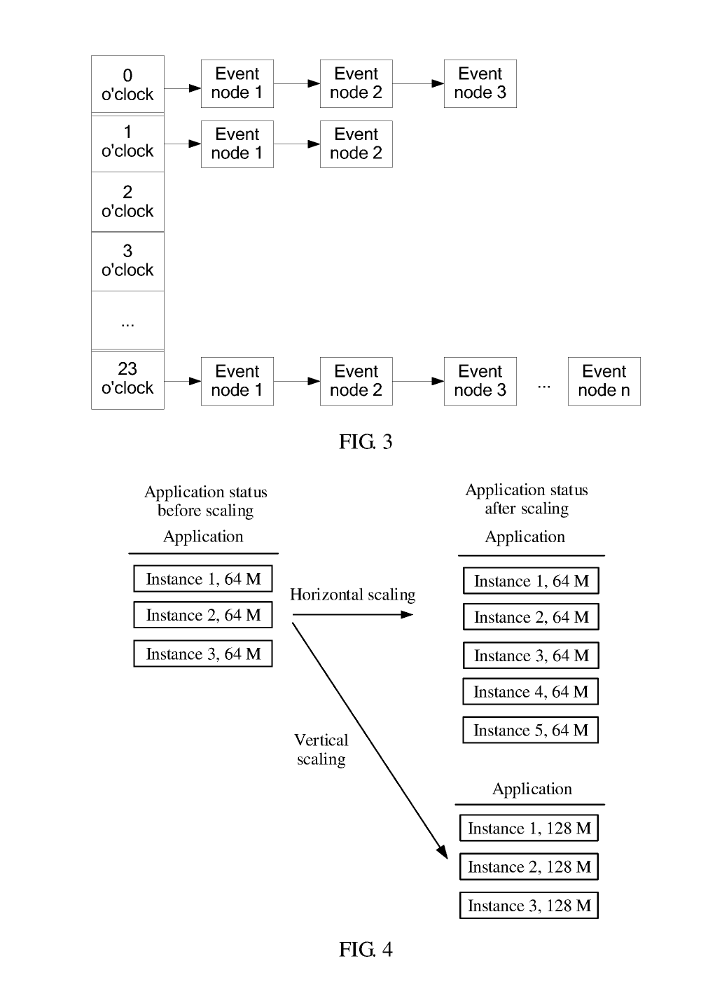

As shown in FIG. 3, an embodiment of the present disclosure provides a schematic diagram of a storage form of a mapping relationship between a moment and a resource amount required by an application. There are 24 exact hours in total from 0 o'clock to 23 o'clock in FIG. 3. Each exact hour corresponds to one or more event nodes, and each event node includes a mapping relationship between an exact hour and a resource amount required by the application at the exact hour. For example, an event node 1 corresponding to 0 o'clock includes: a quantity of instances deployed by the application at 0:10 is three. In the mapping relationship between a moment and a resource amount required by the application shown in FIG. 3, the mapping relationship between a moment and a resource amount required by the application may be added or deleted by adding or deleting an event node corresponding to an exact hour.

The method for predicting, based on the mapping relationship between a moment and a resource amount required by the application shown in FIG. 3, the resource amount required by the application at the second moment is as follows:

An exact hour in the mapping relationship shown in FIG. 3 may be quickly locked at the first moment (usually a current moment) according to an exact hour of the first moment. Then, an event node corresponding to the locked exact hour is searched for an event node corresponding to the second moment, and the resource amount required by the application at the second moment is determined according to the event node. For example, at a first moment 0:05, an event node corresponding to 0 o'clock in the mapping relationship shown in FIG. 3 is locked according to a second moment 0:10, and it is determined that a moment included in the event node 1 corresponding to 0 o'clock coincides with the second moment. Therefore, it is determined that a quantity of instances that need to be deployed on the application at the second moment (0:10) is three.

It should be noted that, in this embodiment of the present disclosure, the mapping relationship between a moment and a resource amount required by the application is not limited to a form shown in FIG. 3, and may be in another form.

FIG. 4 is a schematic diagram of a before-after scaling effect of a resource amount of an application. Horizontal scaling refers to adjustment of an instance quantity of the application, and vertical scaling refers to adjustment of memory of the application. The instance quantity of the application is three before the horizontal scaling. By means of the technical solution in Embodiment 2, the instance quantity of the application is horizontally scaled to five before the second moment arrives. The memory of the application is 64 M before the vertical scaling. By means of the technical solution in Embodiment 2, the memory of the application is vertically scaled to 128 M before the second moment arrives. Therefore, before the second moment (usually the service traffic burst moment) arrives, normal running of the application can be ensured.

By means of the technical solution in Embodiment 2, resources are dynamically allocated to an application deployed on a cloud platform. A service traffic burst moment may be set as a second moment, to dynamically adjust, by using the technical solution in Embodiment 2 before the service traffic burst moment arrives, a resource amount required by the application deployed on the cloud platform, so that in a service traffic burst scenario, the resource amount allocated to the application deployed on the cloud platform can maintain normal service running of the application, while high resource usage is ensured. Because operating costs of the application are directly proportional to a resource amount occupied by the application, by means of the technical solution in Embodiment 2, resource wastes and relatively high operating costs that are caused by allocating excessive cloud platform resources to the application are avoided.

Based on the foregoing method embodiment, an embodiment of the present disclosure provides a cloud platform for dynamically allocating resources to an application deployed on the cloud platform. The application is used to implement a service function. The cloud platform predicts, before a service traffic burst moment, a resource amount required by the application at the traffic burst moment, and adjusts, before the service traffic burst moment, a resource amount of the application to the predicted resource amount required by the application at the service traffic burst moment. When a resource is dynamically allocated to the application deployed on the cloud platform, it is ensured that in a service traffic burst scenario, sufficient resources can still be allocated to the application deployed on the cloud platform, to perform normal service running.

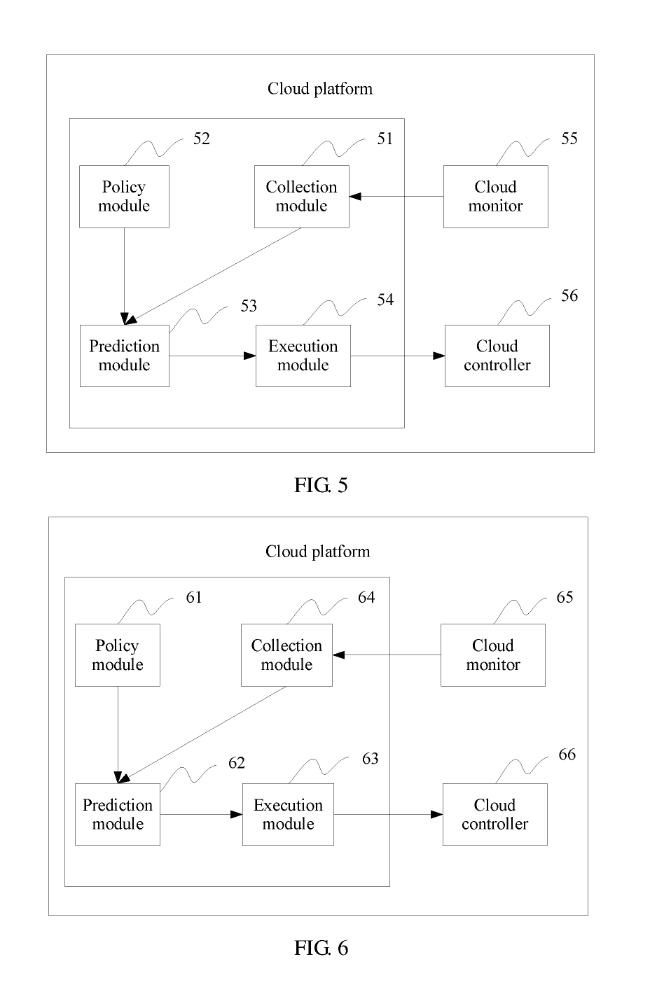

As shown in FIG. 5, an embodiment of the present disclosure provides a cloud platform. The cloud platform includes at least a collection module 51, a policy module 52, a prediction module 53, and an execution module 54. A specific operation of each module is as follows.

The collection module 51 is configured to collect a service indicator of a service before a first moment. The service herein is specifically borne or implemented by an application.

The policy module 52 is configured to configure a mapping relationship between a service indicator and a resource amount required by the application.

The prediction module 53 is configured to: predict, at the first moment according to the service indicator of the service that is before the first moment and collected by the collection moduled 51, a service indicator of the service that is at a second moment, to obtain a predicted service indicator, where the second moment is later than the first moment; and determine, according to the predicted service indicator and the mapping relationship that is between a service indicator and a resource amount required by the application and that is configured by the policy module 52, a resource amount required by the application at the second moment.

The execution module 54 is configured to adjust, before the second moment arrives, a resource amount of the application to the resource amount that is required by the application at the second moment and determined by the prediction module 53.

In this embodiment, for predicting the service indicator of the service that is at the second moment by the prediction module 53, the following provides two specific implementation manners.

A first implementation manner is a service indicator prediction manner based on historical data.

Specifically, the collection module 51 collects a service indicator of the service that is within a preset time interval before the first moment.

The prediction module 53 determines a change track of the service indicator of the service that is within the preset time interval before the first moment according to the service indicator of the service that is within the preset time interval before the first moment and collected by the collection module 51, and predicts the service indicator of the service that is at the second moment according to the change track.

The preset time interval includes a third moment and a fourth moment that are adjacent to each other, and the change track indicates a value relationship between a service indicator of the service at the third moment and a service indicator of the service at the fourth moment and an increased or decreased value of the service indicator of the service at the fourth moment compared with the service indicator of the service at the third moment.

A second implementation manner is a service indicator prediction manner based on a specified time.

Specifically, the collection module 51 collects a service indicator of the service that is at a historical moment before the first moment. The historical moment includes at least one moment, a time interval between any moment in the historical moment and the second moment is N preset periods, and N is a positive integer.

The prediction module 53 predicts the service indicator of the service that is at the second moment according to the service indicator of the service that is at the historical moment before the first moment and collected by the collection module 51.

For the first implementation manner or the second implementation manner, optionally, the collection module 51 collects, by using a cloud monitor 55, the service indicator of the service that is before the first moment.

In this embodiment of the present disclosure, optionally, the execution module 54 sends an instruction to a cloud controller 56 to adjust the resource amount of the application to the resource amount required by the application at the second moment. The instruction is used to instruct the cloud platform controller to adjust the resource amount of the application to the resource amount required by the application at the second moment.

In this embodiment of the present disclosure, the mapping relationship between a service indicator and a resource amount required by the application may be manually configured. For example, the mapping relationship between a service indicator and a resource amount required by the application is configured based on personal experience or authoritative data from a third-party company. Alternatively, the mapping relationship between a service indicator and a resource amount required by the application may be automatically calculated. That is, a resource amount that is required by an application and that corresponds to a service indicator is calculated according to historical running status information of the application, to complete configuration of the mapping relationship between a service indicator and a resource amount required by the application.

A resource is dynamically allocated, by using the cloud platform provided in the foregoing embodiments, to an application deployed on the cloud platform. A service traffic burst moment may be set as a second moment, to dynamically adjust, by using the cloud platform provided in Embodiment 3 before the service traffic burst moment arrives, a resource amount required by the application deployed on the cloud platform, so that in a service traffic burst scenario, the resource amount allocated to the application deployed on the cloud platform can maintain normal service running of the application, while high resource usage is ensured. Because operating costs of the application are directly proportional to a resource amount occupied by the application, by means of the cloud platform provided in Embodiment 3, resource wastes and relatively high operating costs that are caused by allocating excessive cloud platform resources to the application are avoided.

As shown in FIG. 6, an embodiment of the present disclosure provides a cloud platform. The cloud platform includes at least a policy module 61, a prediction module 62, and an execution module 63. Optionally, the cloud platform further includes a collection module 64. A specific operation of each module is as follows.

The policy module 61 is configured to configure a mapping relationship between a moment and a resource amount required by an application.

The prediction module 62 is configured to predict, at a first moment according to a second moment and the mapping relationship that is between a moment and a resource amount required by the application and that is configured by the policy module 61, a resource amount required by the application at the second moment. The second moment is later than the first moment.

The execution module 63 is configured to adjust, before the second moment arrives, a resource amount of the application to the resource amount that is required by the application at the second moment and determined by the prediction module 62.

In this embodiment, the resource amount of the application may be at least one of the following: a quantity of instances deployed by the application, central processing unit CPU usage of the application, memory usage of the application, disk usage of the application, or a network input/output I/O device throughput occupied by the application.

In this embodiment, the first moment is usually a current moment, the second moment is usually a service traffic burst moment, and the second moment is later than the first moment. For example, when it can be determined, according to past experience, that a service traffic burst case will occur within a period of time, such as holidays or a buying spree time, a start moment of this period of time may be set as the second moment. Alternatively, the second moment may be set as another moment, and this is not specifically limited in this embodiment of the present disclosure. Optionally, a time interval between the first moment and the second moment is greater than or equal to a time required for adjusting the resource amount of the application.

In this embodiment of the present disclosure, optionally, the cloud platform further includes the collection module 64, configured to collect a resource amount required by the application at a historical moment.

In this case, the policy module 61 configures, according to the resource amount that is required by the application at the historical moment and collected by the collection module 64, the mapping relationship between a moment and a resource amount required by the application.

Optionally, the collection module 64 collects, by using a cloud monitor 65, the resource amount required by the application at the historical moment.

In this embodiment of the present disclosure, optionally, the execution module 63 sends an instruction to a cloud controller 66 to adjust the resource amount of the application to the resource amount required by the application at the second moment. The instruction is used to instruct the cloud platform controller to adjust the resource amount of the application to the resource amount required by the application at the second moment.

In this embodiment of the present disclosure, the mapping relationship between a moment and a resource amount required by the application may be based on a historical moment and a resource amount required by the application at the historical moment. Specifically, the mapping relationship between a moment and a resource amount required by the application may be automatically calculated. That is, a resource amount that is required by an application and that corresponds to a moment is calculated according to historical running status information of the application, to complete configuration of the mapping relationship between a moment and a resource amount required by the application. Alternatively, the mapping relationship between a moment and a resource amount required by the application may be manually configured. For example, the mapping relationship between a moment and a resource amount required by the application is configured based on personal experience or authoritative data from a third-party company.

As shown in FIG. 3, an embodiment of the present disclosure provides a schematic diagram of a storage form of a mapping relationship between a moment and a resource amount required by an application. For details of a process of predicting, by the cloud platform shown in FIG. 6 based on the mapping relationship between a moment and a resource amount required by the application in FIG. 3, the resource amount required by the application at the second moment, refer to the foregoing embodiments. The details are not described herein.

A resource is dynamically allocated, by using the cloud platform provided in this embodiment of the present disclosure, to an application deployed on the cloud platform. A service traffic burst moment may be set as a second moment, to dynamically adjust, by using the cloud platform provided in Embodiment 4 before the service traffic burst moment arrives, a resource amount required by the application deployed on the cloud platform, so that in a service traffic burst scenario, the resource amount allocated to the application deployed on the cloud platform can maintain normal service running of the application, while high resource usage is ensured. Because operating costs of the application are directly proportional to a resource amount occupied by the application, by means of the cloud platform provided in Embodiment 4, resource wastes and relatively high operating costs that are caused by allocating excessive cloud platform resources to the application are avoided.

It should be noted that, the resource scaling method on a cloud platform provided in the present disclosure and the corresponding cloud platform are not independent of each other. For related technical details of the apparatus embodiment, refer to the corresponding method embodiment.

Persons skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage medium (including but not limited to a disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processor of another programmable data processing device to generate a machine, so that the instructions executed by a computer or a processor of another programmable data processing device generate an apparatus for implementing a specified function in one or more processes in the flowcharts and/or in one or more blocks in the block diagrams.

These computer program instructions may be stored in a computer readable memory that can instruct the computer or another programmable data processing device to work in a particular manner, so that the instructions stored in the computer readable memory generate a manufacture that includes an instruction apparatus. The instruction apparatus implements a specified function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specified function in one or more processes in the flowcharts and/or in one or more blocks in the block diagrams.

Although some embodiments of the present disclosure have been described, persons skilled in the art can make changes and modifications to these embodiments once they learn the basic inventive concept. Therefore, the following claims are intended to be construed as covering the embodiments and all changes and modifications falling within the scope of the present disclosure.

Obviously, persons skilled in the art can make various modifications and variations to the embodiments of the present disclosure without departing from the spirit and scope of the embodiments of the present disclosure. The present disclosure is intended to cover these modifications and variations provided that they fall within the scope of protection defined by the following claims and their equivalent technologies.

What is claimed is:

1. A resource scaling method, comprising:
predicting, at a first moment according to a prediction policy for dynamically allocating resources to an application deployed on a cloud platform and bearing a corresponding service, a service indicator of the service that is at a second moment, to obtain a predicted service indicator, wherein the prediction policy indicates a prediction manner for a service indicator, and the second moment is later than the first moment;
determining, according to the predicted service indicator and a mapping relationship between a service indicator and a resource amount required by the application, a resource amount required by the application at the second moment; and
adjusting, before the second moment arrives, a resource amount of the application to the determined resource amount required by the application at the second moment.

2. The method according to claim 1, wherein the prediction policy comprises a service indicator prediction manner based on historical data; and
wherein the predicting the service indicator of the service that is at the second moment comprises:
obtaining a service indicator of the service that is within a preset time interval before the first moment; and
predicting the service indicator of the service that is at the second moment according to an obtained value of the service indicator of the service that is within a preset time interval before the first moment.

3. The method according to claim 2, wherein the predicting the service indicator of the service that is at the second moment according to the obtained value of the service indicator comprises:
determining a change track of the service indicator of the service that is within the preset time interval according to the obtained value of the service indicator, and predicting the service indicator of the service that is at the second moment according to the change track;
wherein the preset time interval comprises a third moment and a fourth moment that are adjacent to each other, and the change track indicates a value relationship between a service indicator of the service at the third moment and a service indicator of the service at the fourth moment and an increased or decreased value of the service indicator of the service at the fourth moment compared with the service indicator of the service at the third moment.

4. The method according to claim 1, wherein the prediction policy comprises a service indicator prediction manner based on a specified time; and
wherein the predicting the service indicator of the service that is at a second moment comprises:
obtaining a service indicator of the service that is at a historical moment before the first moment; and
predicting the service indicator of the service that is at the second moment according to an obtained value of the service indicator of the service that is at a historical moment before the first moment;
wherein the historical moment comprises at least one moment, wherein a time interval between any moment in the historical moment and the second moment is N preset periods, and wherein N is a positive integer.

5. The method according to claim 1, wherein the service indicator of the service comprises one of, or a combination of, a concurrent request quantity of the service, access traffic of the service, a Hypertext Transfer Protocol (HTTP) request quantity of the service, or a user quantity of the service.

6. The method according to claim 1, wherein the adjusting a resource amount of the application to the resource amount required by the application at the second moment comprises:
sending an instruction to a cloud platform controller, wherein the instruction is used to instruct the cloud platform controller to adjust the resource amount of the application to the determined resource amount required by the application at the second moment.

7. The method according to claim 1, wherein the resource amount of the application comprises one of, or a combination of, a quantity of instances deployed by the application, central processing unit (CPU) usage of the application, memory usage of the application, disk usage of the application, or a network input/output (I/O) device throughput used by the application.

8. A resource scaling method for dynamically allocating resources to an application deployed on a cloud platform and bearing a corresponding service, the method comprising:
predicting, at a first moment according to a mapping relationship between a moment and a resource amount required by the application, a resource amount required by the application at a second moment, wherein the second moment is later than the first moment; and
adjusting, before the second moment arrives, a resource amount of the application to the predicted resource amount required by the application at the second moment.

9. The method according to claim 8, wherein the adjusting the resource amount of the application to the resource amount required by the application at the second moment comprises:
sending an instruction to a cloud platform controller, wherein the instruction instructs the cloud platform controller to adjust the resource amount of the application to the predicted resource amount required by the application at the second moment.

10. The method according to claim 8, wherein the resource amount of the application comprises one of, or a combination of, a quantity of instances deployed by the application, central processing unit (CPU) usage of the application, memory usage of the application, disk usage of the application, or a network input/output (I/O) device throughput used by the application.

11. A cloud platform, comprising
a processor; and
a non-transitory computer-readable storage medium storing a program to be executed by the processor for dynamically allocating resources to an application deployed on the cloud platform bearing a corresponding service, the program including instructions to:
collect a service indicator of the service that is before a first moment;
configure a mapping relationship between a service indicator and a resource amount required by the application;
predict, at the first moment according to the service indicator of the service that is collected, a service indicator of the service that is at a second moment, to obtain a predicted service indicator, wherein the second moment is later than the first moment;
determine, according to the predicted service indicator and the mapping relationship that is configured, a resource amount required by the application at the second moment; and
adjust, before the second moment arrives, a resource amount of the application to the determined resource amount that is required by the application at the second moment.

12. The cloud platform according to claim ii, wherein the program further includes instructions to:
collect a service indicator of the service that is within a preset time interval before the first moment.

13. The cloud platform according to claim 12, wherein the program further includes instructions to:
determine a change track of the service indicator of the service that is collected within the preset time interval before the first moment according to the service indicator of the service that is within the preset time interval; and
predict the service indicator of the service that is at the second moment according to the change track;
wherein the preset time interval comprises a third moment and a fourth moment that are adjacent to each other, and wherein the change track indicates a value relationship between a service indicator of the service at the third moment and a service indicator of the service at the fourth moment and an increased or decreased value of the service indicator of the service at the fourth moment compared with the service indicator of the service at the third moment.

14. The cloud platform according to claim ii, wherein the program further includes instructions to:
collect a service indicator of the service that is at a historical moment before the first moment, wherein the historical moment comprises at least one moment, wherein a time interval between any moment in the historical moment and the second moment is N preset periods, wherein and N is a positive integer.

15. The cloud platform according to claim 14, wherein the program further includes instructions to:
predict a service indicator of the service that is at the second moment according to the service indicator of the service that is collected at the historical moment before the first moment.

16. The cloud platform according to claim ii, wherein the service indicator of the service comprises one of, or a combination of, a concurrent request quantity of the service, access traffic of the service, a Hypertext Transfer Protocol (HTTP) request quantity of the service, or a user quantity of the service.

17. The cloud platform according to claim ii, wherein the resource amount of the application comprises any one or a combination of the following information: a quantity of instances deployed by the application, central processing unit (CPU) usage of the application, memory usage of the application, disk usage of the application, or a network input/output (I/O) device throughput used by the application.

18. A cloud platform, comprising:
a processor; and
a non-transitory computer-readable storage medium storing a program to be executed by the processor for dynamically allocating resources to an application deployed on the cloud platform and bearing a corresponding service, the program including instructions to:
configure a mapping relationship between a moment and a resource amount required by the application;
predict, at a first moment according to a second moment and the mapping relationship that is configured, a resource amount required by the application at the second moment, wherein the second moment is later than the first moment; and
adjust, before the second moment arrives, a resource amount of the application to the determined resource amount that is required by the application at the second moment.

19. The cloud platform according to claim 18, wherein the program further includes instructions to:
collect a resource amount required by the application at a historical moment;
configure, according to the resource amount that is required by the application and collected at the historical moment, the mapping relationship between a moment and a resource amount required by the application.

20. The cloud platform according to claim 18, wherein the resource amount of the application comprises one of, or a combination of, a quantity of instances deployed by the application, central processing unit CPU usage of the application, memory usage of the application, disk usage of the application, or a network input/output (I/O) device throughput used by the application.
